(19) United States
(12) Patent Application Publication
(10) Pub. No.: US 2023/0108234 A1
(43) Pub. Date: Apr. 6, 2023

(54) SYNCHRONOUS LABELING OF OPERATIONAL STATE FOR WORKLOADS

(71) Applicants: ADVANCED MICRO DEVICES, INC., Santa Clara, CA (US); ATI TECHNOLOGIES ULC, MARKHAM (CA)

(72) Inventors: Joseph L. Greathouse, Austin, TX (US); Stephen Kushnir, Ontario (CA); Karthik Rao, Cedar Park, TX (US); Leopold Grinberg, Boxborough, MA (US)

(21) Appl. No.: 17/487,472

(22) Filed: Sep. 28, 2021

(51) Int. Cl. G06F 9/48; G06F 9/52

(52) U.S. Cl. CPC G06F 9/4893; G06F 9/52

(57) ABSTRACT

A processing system adjusts an operating state of one or more processors during execution of a workload based on a command paired with the workload. The command specifies a desired operating state or a performance or power efficiency target operational goal and is enqueued asynchronously with the workload. A power management controller reads the command synchronously with dispatching the workload to the processor. By asynchronously enqueuing the tag with the workload, the processing system tunes the operating state of the processor to reach higher performance, higher performance per watt, and/or higher energy efficiency during processing of the workload.

### BACKGROUND

Power is a limiting factor in modern microprocessor performance, and particularly in heterogeneous processing systems that include one or more central processing units (CPUs) and one or more parallel processors. Conventionally, workloads are asynchronously enqueued to the parallel processor and then returned to the CPU. However, different workloads executing at a heterogeneous processing system have different frequency or power targets to reach optimal energy, thermal, or performance per watt. Setting ideal operating states of the components of the heterogeneous processing system synchronously with execution of the workloads is a challenge, often resulting in a mismatch between setting the operating state of each component and the time when the workload is executed at each of the components.

### BRIEF DESCRIPTION OF THE DRAWINGS

The present disclosure is better understood, and its numerous features and advantages made apparent to those skilled in the art by referencing the accompanying drawings. The use of the same reference symbols in different drawings indicates similar or identical items.

FIG. 1 is a block diagram of a processing system configured to execute a command indicating an operating state of a component of the processing system during execution of a workload in accordance with some embodiments.

FIG. 2 is a block diagram of a command indicating a power/frequency set point of a processor in accordance with some embodiments.

FIG. 3 is a block diagram of a command indicating a performance/efficiency target operational goal in accordance with some embodiments.

FIG. 4 is a block diagram of a scheduler of the processing system of FIG. 1 signaling a power management controller to set the operating state of a processor based on the command during execution of the workload in accordance with some embodiments.

FIG. 5 is a block diagram of an arbitration module of the power management controller applying an arbitration policy to prioritize competing commands to set operating states during execution of a plurality of workloads in accordance with some embodiments.

FIG. 6 is a block diagram of a portion of the heterogeneous processing system including a sequencer for providing timing information for workloads to the power management controller in accordance with some embodiments.

FIG. 7 is a timing diagram of operating states for a first workload and a second workload based on commands paired with the first and second workloads in accordance with some embodiments.

FIG. 8 is a flow diagram illustrating a method for adjusting an operating state of a processor during execution of a workload based on a command paired with the workload in accordance with some embodiments.

### DETAILED DESCRIPTION

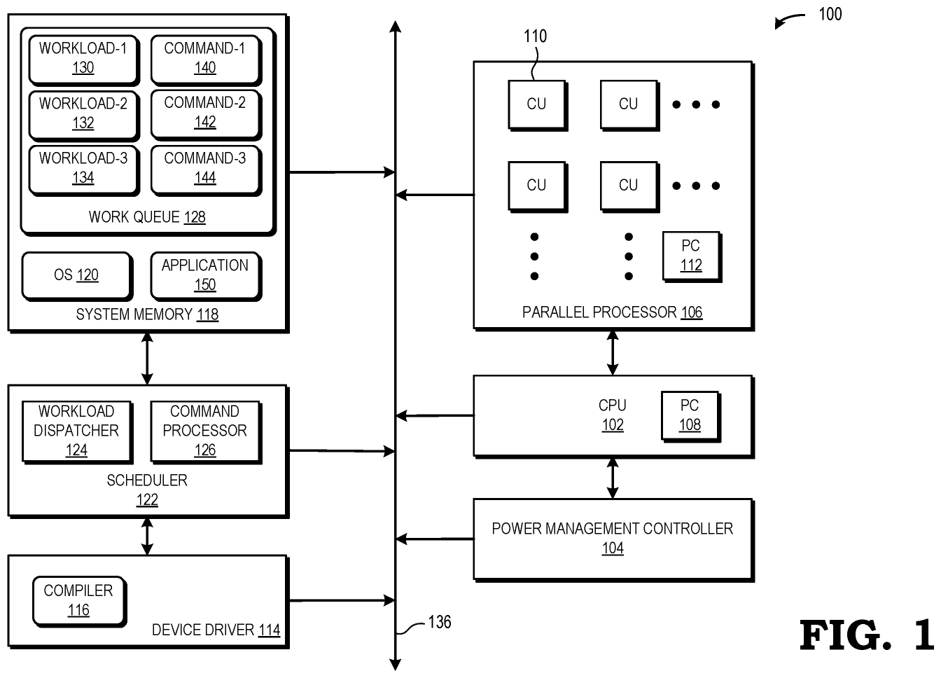

FIGS. 1-8 illustrate systems and techniques for adjusting an operating state of one or more processors of a heterogeneous processing system during execution of a workload based on a tag (also referred to herein as a command) paired with the workload. The workload is a software workload that executes partially at a CPU and partially at one or more parallel processors of the heterogeneous processing system, and both the tag and the workload are submitted asynchronously to the one or more parallel processors. In some embodiments, the tag represents a command that specifies a desired operating state, such as a power or frequency setting of the processor. In other embodiments, the tag represents a command that specifies a performance or power efficiency target, such as high compute throughput or high memory throughput. In other embodiments, the tag describes the workload. The processing system enqueues the tag with the workload and passes the tag to a power management controller synchronously with dispatching the workload to the processor. By asynchronously enqueuing the tag with the workload, the processing system tunes the operating state of the processor to reach higher performance, higher performance per watt, and/or higher energy efficiency during processing of the workload.

In the event that processing of two or more workloads that are paired with tags specify conflicting operating states or specify performance/efficiency targets with processing times that overlap, in some embodiments the processing system employs an arbitration policy to select an operating state of the processor at each phase of processing of the workloads. In some embodiments, the processing system tracks the progress of workloads paired with commands specifying conflicting operating states or performance/efficiency targets as they are executed at the processor. If execution of two or more workloads overlap, once a first workload has completed executing at the processor at the operating state or target operational goal specified by a tag paired with the first workload, the processor switches to the operating state or target operational goal specified by the tag paired with the next workload.

FIG. 1 illustrates a processing system configured to execute a command indicating an operating state of a component of the processing system during execution of a workload in accordance with some embodiments. The processing system 100 includes a central processing unit (CPU) 102 and a parallel processing unit (PPU) 106, also referred to herein as parallel processor 106. In various embodiments, the CPU 102 includes one or more single- or multi-core CPUs. In various embodiments, the parallel processor 106 includes any cooperating collection of hardware and/or software that perform functions and computations associated with accelerating graphics processing tasks, data parallel tasks, nested data parallel tasks in an accelerated manner with respect to resources such as conventional CPUs, conventional graphics processing units (GPUs), and combinations thereof. In the embodiment of FIG. 1, the processing system 100 is formed on a single silicon die or package that combines the CPU 102 and the parallel processor 106 to provide a unified programming and execution environment. This environment enables the parallel processor 106 to be used as fluidly as the CPU 102 for some programming tasks. In other embodiments, the CPU 102 and the parallel processor 106 are formed separately and mounted on the same or different substrates. It should be appreciated that processing system 100 may include one or more software, hardware, and firmware components in addition to or different from those shown in FIG. 1. For example, processing system 100 may additionally include one or more input interfaces, non-volatile storage, one or more output interfaces, network interfaces, and one or more displays or display interfaces.

As illustrated in FIG. 1, the processing system 100 also includes a system memory 118, an operating system 120, a communications infrastructure 136, and a power management controller 104. Access to system memory 118 is managed by a memory controller (not shown), which is coupled to system memory 118. For example, requests from the CPU 102 or other devices for reading from or for writing to system memory 118 are managed by the memory controller. In some embodiments, one or more applications 150 include various programs or commands to perform computations that are also executed at the CPU 102. The CPU 102 sends selected commands for processing at the parallel processor 106. The operating system 120 and the communications infrastructure 136 are discussed in greater detail below. The processing system 100 further includes a device driver 114 and a memory management unit, such as an input/output memory management unit (IOMMU) (not shown). Components of processing system 100 may be implemented as hardware, firmware, software, or any combination thereof.

Within the processing system 100, the system memory 118 includes non-persistent memory, such as DRAM (not shown). In various embodiments, the system memory 118 stores processing logic instructions, constant values, variable values during execution of portions of applications or other processing logic, or other desired information. For example, parts of control logic to perform one or more operations on CPU 102 may reside within system memory 118 during execution of the respective portions of the operation by CPU 102. During execution, respective applications such as application 150, operating system functions such as operating system 120, processing logic commands, and system software reside in system memory 118. Control logic commands that are fundamental to operating system 120 generally reside in system memory 118 during execution. In some embodiments, other software commands (e.g., device driver 114) also reside in system memory 118 during execution of processing system 100.

In various embodiments, the communications infrastructure 136 interconnects the components of processing system 100. Communications infrastructure 136 includes (not shown) one or more of a peripheral component interconnect (PCI) bus, extended PCI (PCI-E) bus, advanced microcontroller bus architecture (AMBA) bus, advanced graphics port (AGP), or other such communication infrastructure and interconnects. In some embodiments, communications infrastructure 136 also includes an Ethernet network or any other suitable physical communications infrastructure that satisfies an application's data transfer rate requirements. Communications infrastructure 136 also includes the functionality to interconnect components, including components of processing system 100.

A driver, such as device driver 114, communicates with a device (e.g., parallel processor 106) through an interconnect or the communications infrastructure 136. When a calling program invokes a routine in the device driver 114, the device driver 114 issues commands to the device. Once the device sends data back to the device driver 114, the device driver 114 invokes routines in an original calling program. In general, device drivers are hardware-dependent and operating-system-specific to provide interrupt handling required for any necessary asynchronous time-dependent hardware interface. In some embodiments, a compiler 116 is embedded within device driver 114. The compiler 116 compiles source code into program instructions as needed for execution by the processing system 100. During such compilation, the compiler 116 applies transforms to program instructions at various phases of compilation. In other embodiments, the compiler 116 is a stand-alone application.

The CPU 102 includes one or more of a control processor, field programmable gate array (FPGA), application specific integrated circuit (ASIC), or digital signal processor (DSP), although these entities are not shown in FIG. 1 in the interest of clarity. The CPU 102 executes at least a portion of the control logic that controls the operation of the processing system 100. For example, in various embodiments, the CPU 102 executes the operating system 120, the one or more applications 150, and the device driver 114. In some embodiments, the CPU 102 initiates and controls the execution of the one or more applications 150 by distributing the processing associated with one or more applications 150 across the CPU 102 and other processing resources, such as the parallel processor 106.

The parallel processor 106 executes commands and programs for selected functions, such as graphics operations and other operations that may be particularly suited for parallel processing. The parallel processor 106 is a processor that is able to execute a single instruction on a multiple data or threads in a parallel manner. Examples of parallel processors include processors such as graphics processing units (GPUs), massively parallel processors, single instruction multiple data (SIMD) architecture processors, and single instruction multiple thread (SIMT) architecture processors for performing graphics, machine intelligence or compute operations. In some implementations, parallel processors are separate devices that are included as part of a computer. In other implementations such as advance processor units, parallel processors are included in a single device along with a host processor such as a central processor unit (CPU). In general, parallel processor 106 is frequently used for executing graphics pipeline operations, such as pixel operations, geometric computations, and rendering an image to a display. In some embodiments, parallel processor 106 also executes compute processing operations (e.g., those operations unrelated to graphics such as video operations, physics simulations, computational fluid dynamics, etc.), based on commands received from the CPU 102. A command can be executed by a special processor, such a dispatch processor, command processor, or network controller.

In various embodiments, the parallel processor 106 includes one or more compute units 110 that are processor cores that include one or more SIMD units (not shown) that execute a thread concurrently with execution of other threads in a wavefront, e.g., according to a single-instruction, multiple-data (SIMD) execution model. The SIMD execution model is one in which multiple processing elements such as arithmetic logic units (ALUs) share a single program control flow unit and program counter and thus execute the same program but are able to execute that program with different data. Some embodiments of the parallel processor 106 are used to implement a GPU and, in that case, the compute units 110 are referred to as shader cores or streaming multi-processors (SMXs). The number of compute units 110 that are implemented in the parallel processor 106 is a matter of design choice.

To support execution of operations, the processing system 100 includes a scheduler 122 and a work queue 128. The scheduler 122 includes a workload dispatcher 124 and a command processor (CP) 126. The work queue 128 stores kernels (i.e., workloads) received from the CPU 102 and other devices of the processing system 100. The CP 126 reads kernels (i.e., workloads) out of the work queue 128 to determine what to dispatch to the parallel processor 106 and receives commands such as command-1 140, command-2 142, and command-3 144 specifying power control information for the corresponding workloads. The workload dispatcher 124 separates the kernels into wavefronts and tracks available resources for the wavefronts and the CUs the wavefronts will run on. Thus, each workload is a set of data that identifies a corresponding set of operations to be executed by the parallel processor 106 or other components of the heterogeneous processing system 100, including operations such as memory accesses, mathematical operations, communication of messages to other components of the heterogeneous processing system 100, and the like.

The scheduler 122 is a set of circuitry that manages scheduling of workloads at components of the heterogeneous processing system 100 such as the parallel processor 106. In response to the CP 126 reading a workload from the work queue 128 and communicating information about the workload to the dispatcher 124, the dispatcher 124 schedules pieces of the workload to the CUs 110. In some embodiments, a given workload is scheduled for execution at multiple compute units. That is, the scheduler 122 schedules the workload for execution at a subset of compute units, wherein the subset includes a plurality of compute units, with each compute unit executing a similar set of operations. The scheduler 122 further allocates a subset of components of the heterogeneous processing system 100 for use by the workload.

As noted above, the scheduler 122 selects the particular subset of CUs 110 to execute a workload based on a specified scheduling protocol. The scheduling protocol depends on one or more of the configuration and type of the parallel processor 106, the types of programs being executed by the associated processing system 100, the types of commands received at the CP 126, and the like, or any combination thereof. In different embodiments, the scheduling protocol incorporates one or more of a number of selection criteria, including the availability of a given subset of compute units (e.g., whether the subset of compute units is executing a wavefront), how soon the subset of compute units is expected to finish executing a currently-executing wavefront, a specified power budget of the processing system 100 that governs the number of CUs 110 that are permitted to be active, the types of operations to be executed by the wavefront, the availability of resources of the parallel processor 106, and the like.

The scheduler 122 further governs the timing, or schedule, of when each workload is executed at the compute units 110. For example, in some cases the scheduler 122 identifies that a workload (such as workload-1 130) is to be executed at a subset of compute units that are currently executing another workload (such as workload-2 132). The scheduler 122 monitors the subset of compute units to determine when the compute units have completed execution of wavefront-2 132. In response to workload-2 132 completing execution, the scheduler 122 provides workload-1 130 to the subset of compute units, thereby initiating execution of workload-1 130 at the subset of compute units.

A power management controller (PMC) 104 carries out power management policies such as policies provided by the operating system 120 implemented in the CPU 102. The PMC 104 controls the power states of the components of the heterogeneous processing system 100 such as the CPU 102, parallel processor 106, system memory 118, and communications infrastructure 136 by changing an operating frequency or an operating voltage supplied to the components of the heterogeneous processing system 100. Some embodiments of the CPU 102 and parallel processor 106 also implement separate power controllers (PCs) 108, 112 to control the power states of the CPU 102 and parallel processor 106, respectively. The PMC 104 initiates power state transitions between power management states of the components of the heterogeneous processing system 100 to conserve power, enhance performance, or achieve other target outcomes. Power management states can include an active state, an idle state, a power-gated state, and some other states that consume different amounts of power. For example, the power states of the parallel processor 106 can include an operating state, a halt state, a stopped clock state, a sleep state with all internal clocks stopped, a sleep state with reduced voltage, and a power down state. Additional power states are also available in some embodiments and are defined by different combinations of clock frequencies, clock stoppages, and supplied voltages.

To facilitate setting operating states of components of the parallel processor 106 and CPU 102 to meet performance or efficiency targets during execution of workloads having varying targets, the work queue 128 stores commands (tags) 140, 142, 144 that are paired with the workloads 130, 132, 134. The commands 140, 142, 144 specify operating states or targets for components of heterogeneous processing system 100 such as the parallel processor 106 during execution of the workloads. For example, in the illustrated example, work queue 128 holds workload-1 130, which is paired with command-1 140, workload-2 132, which is paired with command-2 142, and workload-3 134, which is paired with command-3 144. In some embodiments, the work queue 128 is stored outside system memory 118 at a different storage structure such as a first-in-first-out (FIFO) buffer.

It is also possible for a single command in the work queue 128 to be paired with multiple workloads. For instance, a command may apply to subsequent workloads in the work queue 128 until a subsequent command is reached in the queue. The commands 140, 142, 144 specify operating states or targets of the parallel processor 106, CPU 102, system memory 118, communications infrastructure 136, or other components of the heterogeneous processing system 100 that are to be implemented during execution of the respective paired workloads 130, 132, 134. The commands 140, 142, 144 are set by a user in some embodiments, and specify an operating state such as voltage, frequency, temperature, current draw, and/or voltage margin, or specify a performance or efficiency target, such as high compute throughput or high memory throughput. In some embodiments, the commands 140, 142, 144 include a command to set the operating state to the specified state or target operational goal and a command to run the paired workload 130, 132, 134. In some embodiments, the commands 140, 142, 144 are enqueued in a separate queue from the paired workloads 130, 132, 134 and are accessed synchronously with the paired workloads 130, 132, 134. In other embodiments, the commands 140, 142, 144 are included as meta-information in the paired workloads 130, 132, 134 themselves. In still other embodiments, commands 140, 142, 144 are include as meta-information in data or code pointed to by the workloads 130, 132, 134. These commands may be inserted at workload compilation time by compiler 116 or dynamically by other software when the workload is inserted into work queue 128.

The power management controller 104 accesses the commands 140, 142, 144 and provides the requested operating states to a power controller 108 of the CPU 102 and a power controller 112 of the parallel processor 106 or directly implements the requested operating states in components of the heterogeneous processing system 100 that do not include a separate power controller. In embodiments in which the commands 140, 142, 144 specify a performance or efficiency target operational goal rather than an explicit operating state, the power management controller 104 translates the performance or efficiency target to operating states of the CPU 102 and parallel processor 106 that realize the performance or efficiency targets of the commands 140, 142, 144 and provides the translated operating states to the power controllers 108, 112 or directly implements the translated operating states in components of the heterogeneous processing system 100 that do not include a separate power controller.

By pairing the commands 140, 142, 144 with their respective workloads 130, 132, 134, the commands 140, 142, 144 and workloads 130, 132, 134 are queued asynchronously at the work queue 128, while allowing the operating states indicated by the commands 140, 142, 144 to be implemented synchronously with execution of their respective workloads 130, 132, 134. Pairing the commands 140, 142, 144 with their respective workloads 130, 132, 134 thus mitigates any mismatch between the time of setting the operating state of each component of the heterogeneous processing system 100 for a workload and the time when the workload is executed at each of the components.

As discussed above, in some embodiments, the command that is paired with a workload explicitly describes the desired operating state(s) of one or more components of the heterogeneous processing system 100 during execution of the paired workload. FIG. 2 is a block diagram 200 of a command (command-1 140) indicating a power/frequency set point of a processor in accordance with some embodiments. In the illustrated embodiment, the command-1 140 includes a workload ID 202 and an operating state set point 204. The workload ID 202 identifies the workload with which the command-1 140 is paired. The operating state set point 204 identifies the operating state settings desired to be in effect at one or more components of the heterogeneous processing system 100 during execution of the identified paired workload. The operating state settings include parameters such as voltage, frequency, temperature, and voltage margin.

Employing a command that requests an explicit operating state (referred to herein as a “low-level” tag) requires knowledge of specific characteristics of the components of the heterogeneous processing system 100 for which operating states are requested. For example, voltage and frequency settings that are optimal for execution of particular workloads vary from one model of parallel processor or communications infrastructure to the next. Thus, for example, a request to set a voltage margin of CUs of a particular parallel processor to X volts during execution of a workload will have a different effect than setting the voltage margin of CUs of a different parallel processor to X volts during execution of the same workload.

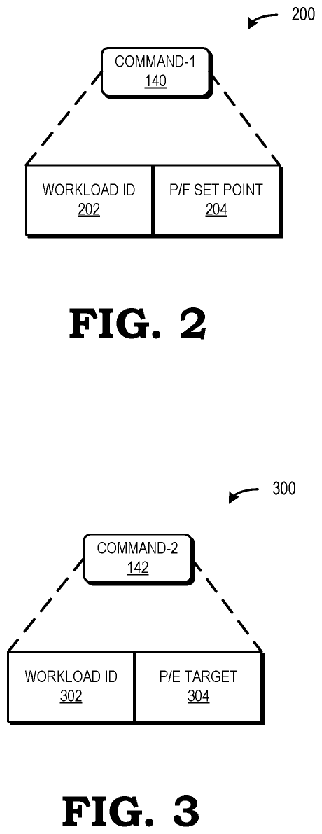

To provide greater flexibility and reduce the need to have knowledge of specific characteristics of components of the heterogeneous processing system 100 while still tuning operating states during execution of workloads having different characteristics, in some embodiments the command paired with each workload specifies a performance or efficiency target operational goal (referred to herein as a “high-level” tag) rather than explicitly defining a desired operating state. FIG. 3 is a block diagram 300 of a command (command-2 142) indicating a performance/efficiency target operational goal in accordance with some embodiments. In the illustrated embodiment, command-2 142 includes a workload ID 302 and a performance/efficiency target operational goal 304. The workload ID 302 identifies the workload with which the command-2 142 is paired. The performance/efficiency target operational goal 304 identifies a performance or efficiency goal that an operating state of one or more components of the heterogeneous processing system 100 are desired to achieve during execution of the identified paired workload. For example, in some embodiments, the performance/efficiency target operational goal 304 specifies that the identified paired workload is intended to be executed at high compute throughput or high memory throughput. The performance/efficiency target operational goal 304 is translated by the PMC 104 into explicit operating state parameters to be implemented at components of the heterogeneous processing system 100. For example, based on its knowledge of the characteristics of the components of the heterogeneous processing system 100, the PMC 104 determines operating state parameters such as voltage, frequency, and voltage margin for one or more components that will accomplish the performance/efficiency target operational goal 304 and implements the operating state parameters either directly or through the PCs 108, 112.

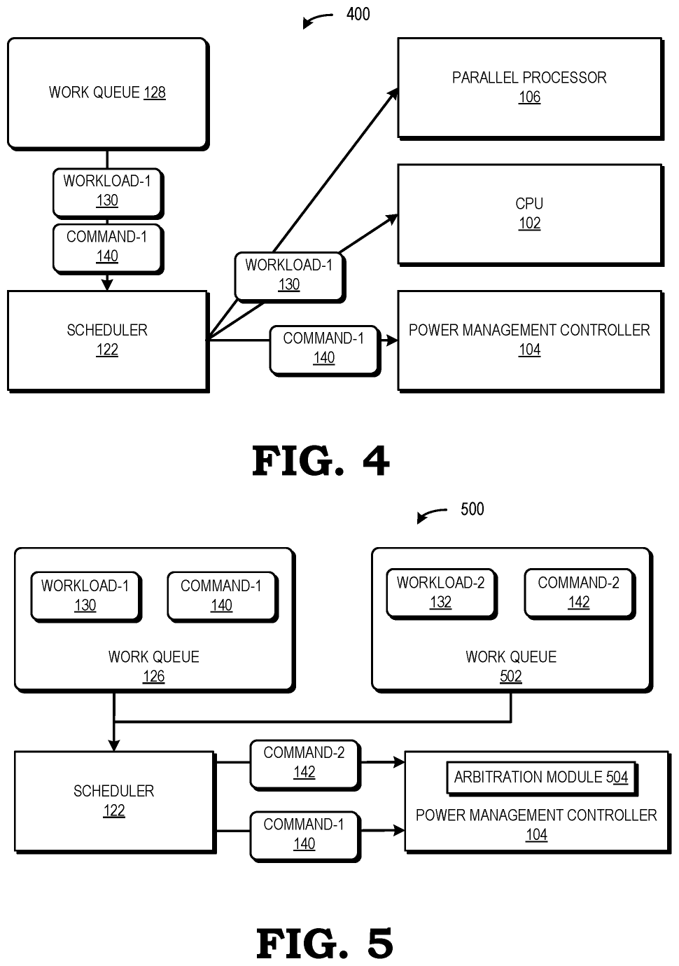

FIG. 4 is a block diagram of the scheduler 122 of the processing system 100 signaling the power management controller 104 to set the operating state of a processor based on a command, command-1 140, paired with the workload-1 130 during execution of the workload-1 130 in accordance with some embodiments. The scheduler 122 reads the workload-1 130 and the command-1 140 from the work queue 128. In some embodiments, the scheduler 122 provides the command-1 140 to the PMC 104 concurrently with dispatching workload-1 130 to one or both of the CPU 102 and the parallel processor 106. The PMC 104 implements the operating state specified by the command-1 140 at the CPU 102 and the parallel processor 106 during execution of workload-1 130. In embodiments in which the command-1 140 indicates a performance or efficiency target operational goal rather than specifying an operating state, the PMC 104 implements an operating state selected to achieve the performance or efficiency target operational goal indicated by the command-1 140.

However, in some instances, providing the command-1 140 to the PMC 104 concurrently with dispatching the workload-1 130 results in the workload-1 130 beginning to execute at the CPU 102 or the parallel processor 106 before the PMC 104 has an opportunity to implement the operating state specified or targeted by the command-1 140. Accordingly, in some embodiments, the scheduler 122 provides the command-1 140 to the PMC 104 prior to dispatching the workload-1 130 and waits for acknowledgement from the PMC 104 that the operating state indicated by the command-1 140 has been implemented before dispatching the workload-1 130.

In some embodiments, multiple workloads paired with commands indicating different operating states or targets are enqueued at a single queue and are in flight (i.e., scheduled to execute) during overlapping time periods. In other embodiments, multiple workloads from multiple processes are separately enqueued and paired with commands indicating different operating states or targets and are scheduled to execute at overlapping times, resulting in competing demands on the power management controller 104. FIG. 5 is a block diagram of a portion 500 of the heterogeneous processing system 100 including an arbitration module 304 of the PMC 104 applying an arbitration policy to prioritize competing commands to set operating states or targets during execution of a plurality of workloads in accordance with some embodiments.

In the illustrated example, the heterogeneous processing system 100 includes two work queues, work queue 128 and work queue 502. Work queue 128 holds workload-1 130, which is paired with command-1 140. Work queue 502 holds workload-2 132 and command-2 142. The scheduler 122 schedules both workload-1 130 and workload-2 132 to execute during overlapping times at components of the heterogeneous processing system 100. The scheduler 122 provides the command-1 140 and the command-2 142 to the power management controller 104. In some embodiments, the command-1 140 and the command-2 142 are low-level tags that each specify an operating state for one or more components of the heterogeneous processing system 100 that is not compatible with the operating state specified by the other. For example, if command-1 140 specifies a frequency of X for the parallel processor 106 and command-2 specifies a frequency of Y for the parallel processor 106, the power management controller 104 will not be able to satisfy both command-1 140 and command-2 142 at the same time.

The arbitration module 504 applies an arbitration policy (not shown) to select among competing requests for operating states for workloads having overlapping execution times. In some embodiments, the arbitration policy is to apply the operating state specified by the most-recently received command. In other embodiments, the arbitration policy is to select an operating state that is an average or other value that is between the competing commands. The arbitration module 504 applies an arbitration policy that considers the respective priorities of the workloads having competing commands in some embodiments. For heterogeneous processing systems that are implemented in battery-powered devices such as laptops or mobile phones, the arbitration policy may prioritize lower power states. Conversely, for workloads that require real-time updates, such as virtual reality applications, higher power states are given priority.

In embodiments in which the command-1 140 and command-2 142 are high-level tags that each specify competing performance/efficiency targets for their respective workloads, the arbitration module 504 selects operating states for the components of the heterogeneous processing system 100 that achieve a balance between the competing targets. For example, if command-1 140 requests high compute throughput and command-2 142 requests high memory throughput, the arbitration module 504 can boost voltage supplied to the parallel processor 106 while also boosting frequency at the system memory 118 within an available power budget.

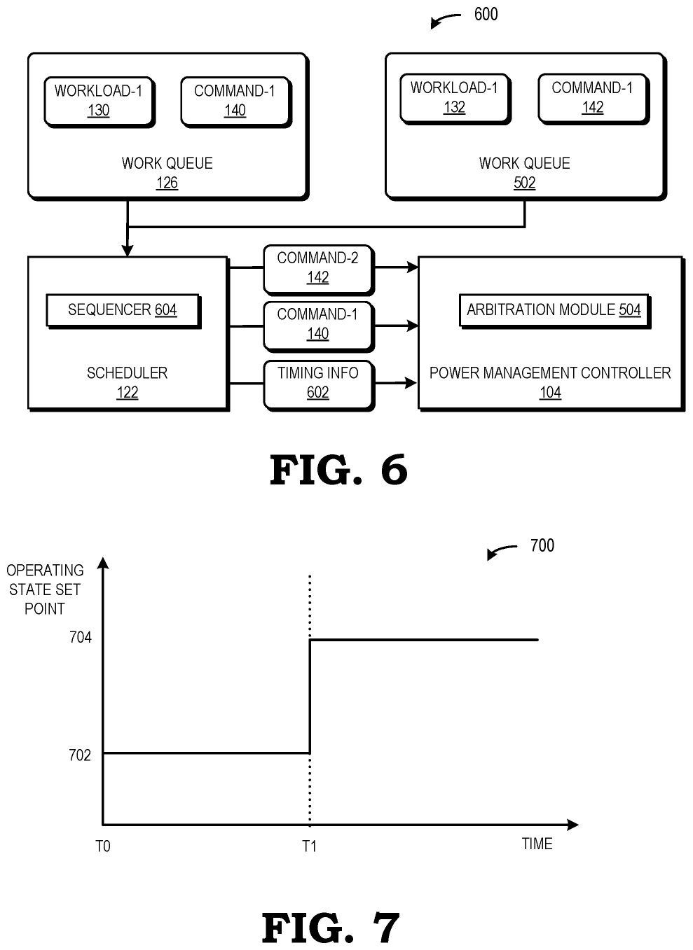

Workloads paired with commands specifying competing operating states or targets that are in flight during overlapping times may execute for varying lengths of time. Thus, one workload will complete execution before another workload that was simultaneously in flight. In some embodiments, the scheduler 122 has visibility into the start times and durations of the workloads and communicates this information to the power management controller 104 to facilitate decision making by the arbitration module 504. FIG. 6 is a block diagram of a portion 600 of the heterogeneous processing system 100 including a sequencer 604 of the scheduler 122 providing timing information 602 for workloads to the power management controller 104 in accordance with some embodiments.

Similar to FIG. 5, in the illustrated example, the heterogeneous processing system 100 includes two work queues, work queue 128 and work queue 502. Work queue 128 holds workload-1 130, which is paired with command-1 140. Work queue 502 holds workload-2 132 and command-2 142. The scheduler 122 schedules both workload-1 130 and workload-2 132 to execute during overlapping times at components of the heterogeneous processing system 100. The scheduler 122 provides the command-1 140 and the command-2 142 to the power management controller 104. The scheduler 122 knows when each of workload-1 130 and workload-2 132 will complete execution. The sequencer 604 determines which of workload-1 130 and workload-2 132 will complete execution first and provides timing information 602 to the power management controller 104. The timing information 602 indicates the start and stop times of each of workload-1 130 and workload-2 132, enabling the power management controller 104 to take the timing information 602 into consideration when selecting among the operating states or targets of command-1 140 and command-2 142. For example, if the timing information 602 indicates that workload-1 130 will complete execution in half the time that workload-2 132 will take to complete execution, the arbitration module 504 implements the operating state or target operational goal specified by command-1 140 during execution of workload-1 130 and then switches to the operating state or target operational goal specified by command-2 142 once workload-1 130 has completed execution. In some embodiments, the scheduler 122 provides timing information 602 that informs the power management controller 104 when workload-1 130 has completed, so that the arbitration module 504 can know that command-1 140 no longer applies.

FIG. 7 is a timing diagram 700 illustrating the arbitration module 504 switching between operating states for a first workload and a second workload based on commands paired with the first and second workloads in accordance with some embodiments. At a time T0, the arbitration module 504 selects a first operating state 702 based on the command-1 140 paired with workload-1 130. Based on the timing information 602 received from the sequencer 604, the arbitration module 504 determines that workload-1 130 completes execution at time T1. Accordingly, at time T1, the arbitration module 504 switches to a second operating state 704 based on the command-2 142 paired with workload-2 132.

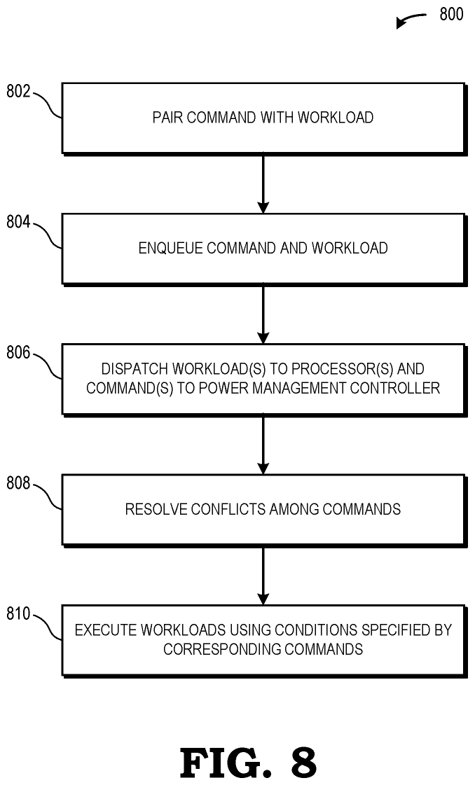

FIG. 8 is a flow diagram illustrating a method 800 for adjusting an operating state of a processor during execution of a workload based on a command paired with the workload in accordance with some embodiments. Method 800 is implemented in a processing system such as heterogeneous processing system 100 of FIG. 1. In some embodiments, method 800 is initiated by one or more processors in response to one or more instructions stored by a computer-readable storage medium.

At block 802, the heterogeneous processing system 100 pairs a command such as command-1 140 with a workload such as workload-1 130. The command-1 140 is set by a user in some embodiments and indicates an operating state set point or a performance/efficiency target operational goal desired to be achieved by one or more components of the heterogeneous processing system 100 during execution of the workload-1 130. At block 804, the command processor 126 enqueues the workload-1 130 and the command-1 140 at the work queue 128. In some embodiments, the workload-1 130 and the command-1 140 are enqueued at separate work queues.

At block 806, the scheduler 122 dispatches the workload-1 130 to one or both of the CPU 102 and the parallel processor 106 and provides the command-1 140 to the power management controller 104. At block 808, the arbitration module 504 of the power management controller 104 applies an arbitration policy to resolve any conflicts among competing commands paired with workloads that are executing during overlapping times at the heterogeneous processing system 100. In some embodiments, the sequencer 604 of the scheduler 122 provides timing information 602 to the arbitration module 504 to be considered in selecting operating states based on commands paired with workloads that are executing during overlapping times. At block 810, the heterogeneous processing system 100 implements operating states for the components of the processing system at which the workload-1 130 is executing based on the command-1 140 and executes the workload-1 130.

In some embodiments, the apparatus and techniques described above are implemented in a system including one or more integrated circuit (IC) devices (also referred to as integrated circuit packages or microchips), such as the processing system described above with reference to FIGS. 1-8. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
indicating, in a first command executed synchronously with a first workload at a processing system comprising a central processing unit (CPU) and parallel processing unit (PPU), a first operating state of at least one of the CPU and the PPU during execution of the first workload.

2. The method of claim 1, further comprising:
receiving, at a scheduler, the first command; and
sending a signal to a power controller of the processing system to set at least one of the CPU and the PPU to the first operating state.

3. The method of claim 2, further comprising:
indicating, in a second command executed synchronously with a second workload at the processing system, a second operating state of at least one of the CPU and the PPU during execution of the second workload.

4. The method of claim 3, wherein execution of the second workload overlaps at least in part with execution of the first workload.

5. The method of claim 4, further comprising:
balancing at least one of the first operating state and the second operating state for at least one of the CPU and the PPU during execution of the first workload and the second workload based on an arbitration policy.

6. The method of claim 5, wherein the arbitration policy is based on at least one of: times when the first command and the second command are received at the scheduler and times when the first command and the second command complete execution.

7. The method of claim 1, wherein the first command comprises a target operational goal.

8. The method of claim 7, wherein the target operational goal comprises at least one of a performance target and an efficiency target.

9. A processing system, comprising:
a central processing unit (CPU);
a parallel processing unit (PPU); and
a memory configured to store a first command executed synchronously with a first workload at the processing system, the first command indicating a first operating state of at least one of the CPU and the PPU during execution of the first workload.

10. The processing system of claim 9, further comprising:
a scheduler to:
receive the first command; and
send a signal to a power controller of the processing system to set at least one of the CPU and the PPU to the first operating state.

11. The processing system of claim 10, wherein the memory is further to store a second command executed synchronously with a second workload at the processing system, the second command indicating a second operating state of at least one of the CPU and the PPU during execution of the second workload.

12. The processing system of claim 11, wherein execution of the second workload overlaps at least in part with execution of the first workload.

13. The processing system of claim 12, further comprising:
an arbitration module to balance at least one of the first operating state and the second operating state for at least one of the CPU and the PPU during execution of the first workload and the second workload based on an arbitration policy.

14. The processing system of claim 13, wherein the arbitration policy is based on at least one of: times when the first command and the second command are received at the scheduler and times when the first command and the second command complete execution.

15. The processing system of claim 9, wherein the first command comprises a target operational goal.

16. A non-transitory computer readable medium embodying a set of executable instructions, the set of executable instructions to manipulate a processor of a processing system comprising a central processing unit (CPU) and parallel processing unit (PPU) to:
indicate, in a first command executed synchronously with a first workload at the processing system, a first operating state of at least one of the CPU and the PPU during execution of the first workload.

17. The non-transitory computer readable medium of claim 16, wherein the set of executable instructions are further to manipulate the processor to:
indicate, in a second command executed synchronously with a second workload at the processing system, a second operating state of at least one of the CPU and the PPU during execution of the second workload.

18. The non-transitory computer readable medium of claim 17, wherein execution of the second workload overlaps at least in part with execution of the first workload.

19. The non-transitory computer readable medium of claim 18, wherein the set of executable instructions are further to manipulate the processor to:
select at least one of the first operating state and the second operating state for at least one of the CPU and the PPU during execution of the first workload and the second workload based on an arbitration policy.

20. The non-transitory computer readable medium of claim 16, wherein the first command comprises a target operational goal.
